(19) United States
(12) Patent Application Publication
(10) Pub. No.: US 2015/0007923 A1
(43) Pub. Date: Jan. 8, 2015

(54) METHOD AND DEVICE FOR JOINING PLASTIC-METAL HYBRID COMPONENTS

(71) Applicants: Michael Sickert, Aachen (DE); Dustin Flock, Koeln (DE); Viktor Mamuschkin, Aachen (DE)

(72) Inventors: Michael Sickert, Aachen (DE); Dustin Flock, Koeln (DE); Viktor Mamuschkin, Aachen (DE)

(21) Appl. No.: 14/375,255

(22) PCT Filed: Jan. 28, 2013
(86) PCT No.: PCT/EP2013/000235

§ 371 Date: Jul. 29, 2014

(30) Foreign Application Priority Data
Feb. 6, 2012 (DE) 10 2012 002 099.6

(51) Int. Cl. B32B 37/04; B32B 41/00

(52) U.S. Cl. CPC B32B 37/04; B32B 41/00
USPC 156/64; 156/196; 156/309.6; 156/358

(57) ABSTRACT

The invention relates to a method for joining plastic-metal hybrid components, in which a metal component (3) is heated up in a heating stage and a plastic component (9) is brought into contact with the heated metal component (3) in a joining stage and joined to the metal component (3) by means of melting in the contact area, wherein in the heating stage the metal component (3) is heated up to a temperature higher than a defined joining temperature, said metal component is cooled down in a subsequent cooling stage in which the temperature of the metal component (3) is recorded by means of at least one temperature measuring device and the joining stage is performed when the defined joining temperature has been reached. The invention further relates to a device for joining a metal component (3) and a plastic component (9), comprising at least one receptacle (2) at a heating location in which the metal component (3) can be placed and comprising a heated/heatable heating die member (4) that can be brought into contact with the metal component (3) by means of an actuator (5) for the purpose of heating the metal component (3), and having a transfer device (10) by means of which the metal component (3) heated up above a predefined joining temperature can be transferred to a joining location, and having a joining die (7) arranged at the joining location, which is driven by means of an actuator (8) and on/in which the plastic element (9) can be held, in particular by means of a vacuum and which has a temperature measuring device by means of which the temperature of the metal component (3) can be recorded, in particular during the cooling at the joining location, and having a control unit by means of which the actuator (8) of the joining die (7) can be controlled depending on the recorded temperature, in particular when a defined joining temperature is reached/not reached.

### CROSS REFERENCE TO RELATED APPLICATIONS

This application is the US-national stage of PCT application PCT/EP2013/000235 filed 28 Jan. 2013 and claiming the priority of German patent application 102012002099.6 itself filed 6 Feb. 2012.

### FIELD OF THE INVENTION

The invention relates to a method of making a plastic-metal component where in a heating step a metal part is heated, and in a joining step a plastic part is engaged with the heated metal part and is joined with the metal part by melting in the contact region. The invention also relates to an apparatus for joining a metal part and a plastic part.

### BACKGROUND OF THE INVENTION

The joining of plastic and metal is basically known from prior art and is done for example by the steps described above. In doing so, it is known to heat a holder for the metal part and to transfer the heat by heat conduction to the metal part for a period of time until the desired temperature is reached and the joining step can occur, after which the entire holder cools down. Due to the total mass being heated and the heating from below to the desired joining temperature, such a method is disadvantageous and imprecise, since the heating and cooling periods are long. In addition, there is no reliable information about the actual temperature reached by the metal part.

### OBJECT OF THE INVENTION

It is therefore an object of the invention to provide a method and an apparatus with which precise joints between plastic and metal parts can be produced in a simple manner and with which short process cycles can be achieved.

### SUMMARY OF THE INVENTION

According to the invention, this object is attained with a method of the type basically described above, in which during the heating step the metal part is heated to a temperature above a predetermined joining temperature, cools off in a subsequent cooling step in which the temperature of the metal part is monitored by at least one temperature measuring apparatus, and the joining step is executed upon reaching the predetermined joining temperature.

Reaching the predetermined joining temperature can be determined in that for example a temperature measured by a temperature sensor or a temperature determined from multiple measured temperatures (for example from the temperature averaged from a plurality of surface regions, particularly the joint region of the metal part) is compared with a joining temperature stored in a controller. In particular, the joining step can be triggered when the measured temperature is less than or equal to the stored joining temperature or is in a predetermined range including the joining temperature.

A key aspect of this method is that the metal part is almost overheated in the heating step, i.e. a temperature is reached that lies above the joining temperature that the metal part is to have at the time of joining. This has the advantage on the one hand that a faster energy input is made possible, since it is no longer necessary to reach the desired joining temperature specifically from below. Rather it is unproblematic and advantageously desired that the metal part reaches a temperature above the desired temperature or the temperature predetermined by the materials.

The advantage of overheating is also seen that in the subsequent cooling step, internal heat conduction in the metal part causes the input energy to be distributed and emitted into the environment.

In this way, a more uniform temperature distribution is achieved in the metal part at the time of the actual joining step, particularly in a shaped joint.

Contrary to the prior art in which the entire holder for the metal part is cyclically heated and cooled, according to the invention the metal part is heated with a heating element that is engaged with the metal part.

For example, the heated die can here be continuously heated such that heat dissipates when it is engaged with the metal part. The dissipating energy quantity can be added back in, for example by supplying energy, for example by feeding current to an electric heating element in the die element.

It may also be provided to select the mass of the heating element to be so large that during the heating step, no or only an insignificant amount of additional energy must be added to the heated die. In this way, for example, the heated die can also only be heated when it has no contact to the metal part.

It may further be provided to engage the heated die with the metal part for a predetermined period of time. This period of time can be selected empirically in such a manner that the temperature of the metal part reliably exceeds the desired or predetermined joining temperature by a certain amount. This period of time can for example be measured starting at the time an actuator is actuated to move the heated die toward the metal part. Also, the moment of contact between the heated die and metal part can be monitored by sensors, for example a photo sensor or force or pressure sensors and the period of time beginning at this moment can be measured.

It may also be provided that during the heating step, the temperature of the metal part is monitored and the heating process is terminated by separating the heated die when the temperature of the metal part has exceeded the predetermined joining temperature by a predetermined amount. For example, the temperature of the metal part can here be monitored in a region that is not covered by the heated die, but in particular is directly connected to it.

An apparatus for carrying out these method steps can accordingly comprise a heated die as well as have suitable actuators for its movement and/or sensors, particularly as is explained in greater detail later on.

In an advantageous embodiment, deformation of the metal part is executed with the heated die during the heating step. In this way, two process steps can be carried out in the time of the heating step, it being particularly advantageous that the deformation pertains to a thermal deformation and therefore yields particularly efficient use of material.

In this case, an actuator for moving the heated die is to be selected so as to be sufficiently powerful to not just execute only contacting for heating purposes, but also to apply the forces required for deforming a metal part.

The execution of the heating by a heated die described here is only a preferred execution variant that however does not limit the method. Heating the metal part beyond the desired joining temperature can also take place in other ways, for example also in a contactless manner, for example by radiation, particularly laser radiation.

Since such radiation commonly has a radiation profile or a radiation cross-section that is smaller than the joint contour, i.e. than a surface region to be heated of the metal part and at which the joining is to occur, it may also be provided in such an embodiment that the radiation profile during the heating step is actively guided over the surface to be heated, i.e. successively passing over the joint contour, for example by deflecting a laser beam, for example a CO₂ laser. Contactless heating with radiation also has the advantage that the temperature of the metal part that is sought during the heating step can be measured contactlessly within the mentioned joint region, for example by evaluating the heat radiation emitted by the metal part from the joint region. Heating can thus be terminated in a very targeted and accurate manner when the metal part exceeds the joining temperature by a certain predetermined amount. Such monitoring of the heat radiation can result for example by a selectively measuring pyrometer or also by a surface-measuring thermal imaging camera.

The process of cooling the metal part that has been heated above the desired joining temperature occurs automatically at the moment when the active heating is terminated, for example when the heated die is withdrawn from the metal part and is no longer in contact with it or heating radiation is shut off. Cooling can then occur by convection and or radiation emission or alternatively also be actively supported, for example by an air or gas flow.

The cooling process can occur in a possible variant at the station of prior heating. However, it can also be provided that the heating step occurs at a heating station and the joining step occurs at a different joining station, particularly in an apparatus comprising both stations, for joining the plastic and metal parts, and the heated metal part is automatically transported to the joining station after the heating step. To this end, a joining apparatus can comprise for example a transfer apparatus or element with which the metal part is transported to the joining station, particularly together with the holder in which it lies and in which the heating occurred.

For example, two holders can be provided that can hold metal parts and the two holders are cyclically run through the heating station and the joining station by the transfer apparatus, for example by a rotary plate. In this way, heating and joining can occur simultaneously.

Regardless of whether the joining station is identical or different from the heating station, a pyrometer or a thermal imaging camera may be used to monitor the cooling process. As already mentioned above, this contactless monitoring has the advantage that the temperature reached by the metal part when cooling can be monitored in at least one region of the metal part that is in a predetermined joint region at which the joining of the metal part and the plastic part is to occur. Therefore, very precise temperature information is obtained exactly at the location at which the joint is to occur later.

Alternatively, the temperature may be monitored in that a temperature sensor is brought in contact with the surface of the metal part, for example in other words a temperature sensor with an sensor tip is applied to the surface.

If temperature monitoring, for example of the aforementioned types, reveals that the temperature in the monitored region of the metal part reaches or falls below the predetermined joining temperature or has approached it to a certain range, then the joining step can be executed. To this end, an actuator for example can be actuated that moves the plastic part to be joined and engages it with the metal part.

To this end, an apparatus for performing the joining can have for example a joining die equipped with an actuator, in/on which the plastic part is held, for example by suction. Such a joining die is preferably provided at a joining station of the apparatus that differs from the heating station.

For example, for a transfer apparatus that is constructed as a rotary plate, the heating station and the joining station may be mutually offset by an angle of rotation, particularly a 180° rotation.

Regarding the provision of separate heating and joining stations, it may be basically provided that joining occurs at a joining station, while a subsequent metal part is simultaneously heated at the heating station.

For all possible embodiments of the invention, during the joining step, the plastic part and the metal part may be pressed together with an initial force and, after a melt film is formed between the components, particularly after a predetermined period has elapsed, they are pressed together with a second, larger force.

In this way, a formed melt film is subjected to an intentional pressure or force application that creates an internal bond, in particular between the components, particularly when they have rough surfaces, for example after sand blasting.

The two different forces can be applied by an actuator pre-adjusted for moving the joining die, without monitoring the forces exactly.

In this embodiment, but also quite generally, at least one measurement sensor, particularly one provided on the joining die, may monitor the forces that occur during joining and adjust them, particularly in relation to the previous embodiment, to the two desired force values.

In particular for an active monitoring of the forces by at least one measurement sensor, it may also be provided however, without any force monitoring, to press together the two components with a predetermined force curve, i.e. a force changing over time for example in such a manner that the force over elapsed time, particularly thus also with increased cooling, is increased or alternatively also decreased.

In another embodiment, during the joining step, i.e. particularly in the time in which a joining die is applied to the metal part by a force and/or pressure sensor, particularly one that is provided on a joining die, when the plastic part is held and engaged with the metal part, the moment of the contact between the plastic part and the metal part may be monitored, particularly by monitoring the moment at which the monitored force or the monitored pressure exceeds a predetermined value. Additional process steps can thus be executed based on this predetermined moment in time.

For example in a joining step after establishing the contact moment by a path sensor, particularly one that is provided on a joining die that holds the plastic part and engages it with the metal part, the melt depth of the plastic part can be monitored. The melt depth is thus the distance that the melting plastic part moves through while pressing against the metal part toward the metal part while pushing through the plastic material melting in the contact zone.

In this way, it can be assured that the melt depth is limited to a predetermined value by relieving the pressure of the joining die.

In a continued development that can occur in all kinds of possible embodiments, the joined plastic-metal hybrid component can be actively cooled in the joining step or after the joining step, for example by an air or gas flow, if applicable also by liquid cooling.

It may be provided here that such active cooling first occurs after the predetermined period of time has elapsed, for example measured starting the moment the joining die is lifted off, or after reaching or falling below a predetermined temperature, particularly one that is actively monitored by the aforementioned temperature sensor or after reaching or exceeding a predetermined melting path that is being measured during the joining process, for example with an incremental value transmitter.

An apparatus according to the invention, with which the above-described method can be carried out, comprises preferably a holder at a heating station in which the metal part can be placed. Such a holder can be formed for example of a material with low heat conduction (less than metal), for example out of PTFE. In addition, the apparatus may be provided with a heated/heatable heated die that can be engaged with the metal part by an actuator for heating the metal part, and a transfer apparatus that can move the metal part heated above a predetermined joining temperature to a joining station where there is a joining die that is driven by an actuator and on/in which the plastic element can be held, particularly by suction and a temperature sensor is still provided that can monitor the temperature of the metal part, particularly during cooling at the joining station, and with a controller that can operate the actuator of the joining die depending on the monitored temperature, particularly on reaching or falling below a predetermined joining temperature.

For quality assurance, in all possible embodiments for every plastic-metal hybrid component produced, information about the temperature reached at the moment of joining can be stored, for example in that the last thermal image that led to triggering the joining step is stored.

It can thus be examined later at any time for checking quality. For example, the stored information, particularly a thermal image, can be linked to a production number of the manufactured hybrid component.

### BRIEF DESCRIPTION OF THE DRAWING

An embodiment is described in greater detail with reference to the attached drawing in which:

FIGS. 1 and 2 are side and front views of the apparatus according to the invention; and

FIG. 3 is a top view of the invention.

### SPECIFIC DESCRIPTION OF THE INVENTION

These drawings show in multiple views an apparatus for joining a plastic part to a metal part, which the method according to the invention carries out.

The apparatus 1 comprises at least a holder 2′ for holding a metal part 3. At a heating station 17 in FIG. 2 on the left, there is a die 4 that can be heated and can be shifted down onto the metal part 3 by an actuator 5. Here, the metal part 3 is shown as a piece of sheet metal; however more complex shapes can be used as the metal part. The heated die 4 can be heated by electric cartridges 6, for example to a temperature significantly higher than the joining temperature desired later. For example, the heated die 4 can have a temperature of about 400° C. A sensor 20 monitors the temperature of the part 3 in the station 17.

At the joining station 18, there is an identical holder 2″. The joining station 18 is shown in FIG. 2 on the right and defined in that a joining die 7 is provided there that can be shifted down toward the holder 2″ by an actuator 8. A plastic part 9 is held in the joining die 7 by suction. This plastic part 9 can be pressed by the joining die 7 onto the heated the metal part 3.

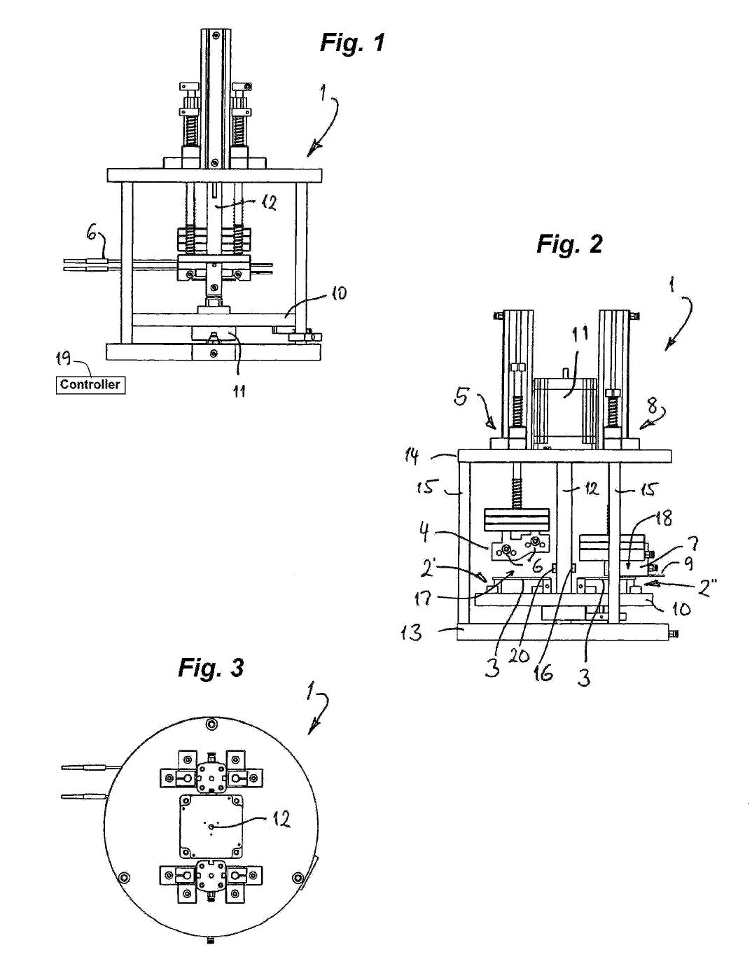

Both the actuators 5 and 8 here operate linearly and can vertically move respective stamps 4 and 7. They are operated by controller 19 shown in FIG. 1.

The two holders 2 are carried on a common transfer apparatus that is constructed here as a turntable 10. Both holders here have an angular separation of 180°. Generally, at least two holders 2′ and 2″ can be provided that are angularly equispaced on the turntable.

Joining can thus be carried out in the one holder 2′, while simultaneously heating can be carried out in the other holder 2″. By rotating the turntable by a drive 11 about an axis of rotation 12, the two holders 2′ and 2″ can be alternated between the heating station 17 and the joining station 18.

The two linear actuators 5 and 8 are arranged as columns next to each other at an angular separation here of also 180° about the axis of rotation 12. In general, the angular separation of the linear actuators 5 and 8 can correspond to that of the holders 2′ and 2″. The movement of both of the dies 4 and 7 takes place by these drives between plates 13 and 14 that carried one above the other on posts 15. The drives of the linear actuators, as well as the rotary drive 11, can be mounted on the upper plate 14.

The method takes place in such a manner that at the heating station 17 (left in FIG. 2), the heated die 4 is engaged with the metal part 3 such that it is heated to a temperature greater than the desired or predetermined joining temperature of, for example, 260° for polyamide. For example, heating to 330° C. can occur. By measuring the temperature with the sensor 20 or by the elapsed time, the end of the heating step is predetermined and the heated die 4 is lifted off and the metal part 3 is transferred to the joining station 18 by rotation of the turntable 10 (right in FIG. 2).

A temperature sensor 16 (for example pyrometer or thermal imaging camera), monitors the temperature of the metal part 3 during cooling and the controller 19 compares the measurement with the desired joining temperature. If the current temperature reaches the desired joining temperature, the joining process is initiated by pressing the plastic part 9, here for example a polyamide panel, held by the joining die 7 against the metal part 3. The plastic part 9 melts and bonds in the melt zone with the metal part 3, whereby the hybrid component is joined.

The joining die 7 can then be lifted off after prior release of the plastic part 9. The hybrid component produced can then cool further, for example passively or actively by an air current, and then be removed from the holder 2 after sufficient cooling, after which the empty holder 2″ is returned to the heating station 17 and the new metal part 3 heated in the meantime is taken to the joining station 18.

1. (canceled)

2. The method according to claim 11, wherein the metal part is heated by engaging a heated die with the metal part for a predetermined period of time or until the temperature of the metal part has exceeded the predetermined joining temperature by a predetermined amount.

3. The method according to claim 2, further comprising the step of:
deforming the metal part with the heated die during the heating step.

4. The method according to claim 11, wherein the temperature of the metal part is monitored by a pyrometer or a thermal imaging camera in at least one region of the metal part in a predetermined joint region at which the joining of the metal part and plastic part is to occur.

5. The method according to claim 11, wherein in the joining step, the plastic part and the metal part are pressed together with a first force and, after a melt film forms between the parts they are pressed together with a second, greater force.

6. The method according to claim 11, further comprising in the joining step and by a force and/or pressure sensor determining a contact moment between the plastic part and the metal part when the monitored force or pressure exceeds a predetermined value.

7. The method according to claim 6, wherein in the joining step after determining the contact moment, a melt depth of the plastic part is monitored, and when the melt depth exceeds a predetermined value by the pressure of the joining die is relieved.

8. The method according to claim 11, wherein in the joining step or after the joining step, the joined plastic-metal hybrid component is actively cooled after
a) a predetermined period has elapsed, or
b) reaching or falling below a predetermined temperature, or
c) reaching or exceeding a predetermined melt depth.

9. The method according to claim 11, wherein the heating step is done at a heating station and the joining step is done at joining station that differs from the heating station, the method further comprising the step of:
automatically transporting the heated metal part after the heating step to the joining station.

10. An apparatus for joining a metal part and a plastic part, the apparatus comprising:
a) at least one holder at a heating station for the metal part,
b) a heated or heatable heated die that can be engaged at the heating station with the metal part by an actuator for heating the metal part,
c) a transfer apparatus that can move the metal part heated above a predetermined joining temperature from the heating station to a joining station,
d) a joining die at the joining station that is driven by an actuator and at/in which the plastic element can be held,
e) a temperature sensor that monitors the temperature of the metal part during cooling at the joining station, and
f) a controller operating the actuator of the joining die on reaching or falling below a predetermined joining temperature.

11. A method of joining a metal part and a plastic part to form a plastic-metal hybrid component, the method comprising the steps of sequentially:
heating the metal part to a temperature above a predetermined joining temperature;
cooling the metal part while monitoring the temperature of the metal part; and
when the monitored temperature is generally equal to the joining temperature, pressing the cooled metal part at the joining temperature against the plastic part and thereby fusing the plastic part to the metal part.
